(19) United States
(12) Patent Application Publication
(10) Pub. No.: US 2015/0024194 A1
(43) Pub. Date: Jan. 22, 2015

(54) ULTRA LOW CURE POWDER COATINGS

(71) Applicant: VALSPAR SOURCING, INC., Minneapolis, MN (US)

(72) Inventors: Thomas E. Reno, Kansas City, MO (US); Wenjing Zhou, Cypress, TX (US); Carlos Concha, Kansas City, MO (US); George O'Dell, Lawson, MO (US)

(73) Assignee: VALSPAR SOURCING, INC., Minneapolis, MN (US)

(21) Appl. No.: 14/450,418

(22) Filed: Aug. 4, 2014

Related U.S. Application Data
(63) Continuation of application No. PCT/US2013/025302, filed on Feb. 8, 2013.

(51) Int. Cl. C09D 5/03

(52) U.S. Cl. CPC C09D 5/03
USPC 428/327; 524/601; 428/458; 427/195

(57) ABSTRACT

Methods and systems for coating metal substrates are provided. The methods and systems include application of TGIC-reactive carboxyl-functional polyester resins with high acid number formulated to cure at low temperatures of 120° C. to 135° C.

### BACKGROUND

Powder coatings are solvent-free, 100% solids coating systems that have been used as low VOC and low cost alternatives to traditional liquid coatings and paints.

Polyester powder coating are sometimes formulated with epoxide crosslinkers such as triglycidyl isocyanurate (TGIC) to provide coatings having optimal hardness, flexibility, weatherability and gloss, among other useful properties. However, TGIC-containing coating compositions cannot typically be cured at temperatures below 140° C. without severely compromising coating properties such as smoothness, gloss, flexibility, and other mechanical properties. The inability to cure at lower temperatures also reduces the usefulness of TGIC-containing powder coatings in temperature-sensitive applications. On the other hand, the use of higher temperature cure cycles to produce effective coatings increases energy costs, especially for large substrates, and reduces coating throughput speed.

From the foregoing, it will be appreciated that there is a need for polyester resin-based powder coatings that can be cured at low temperature, while providing excellent weathering characteristics and durability, without compromising other coating properties such as flexibility, gloss and the like.

### SUMMARY

The powder coating compositions described herein include a carboxyl-functional polyester resin having an acid number of about 45 to 65 and a curing agent or crosslinker. In addition, the composition also includes at least one impact modifier, and an onium ion catalyst. The compositions described herein are capable of being fully cured at temperatures of about 120 to 135° C.

In another embodiment, the present description includes methods for coating a substrate. The method includes providing a substrate and applying on the substrate at least one powder composition, where the powder composition includes a carboxyl-functional polyester resin having an acid number of about 45 to 65 and a curing agent. In addition, the composition also includes at least one impact modifier and an onium ion catalyst. The composition applied to the substrate is then cured at temperatures of about 120 to 135° C.

The details of one or more embodiments and aspects of the invention are set forth below. Other features, objects, and advantages of the invention will be apparent from the description and from the claims.

### SELECTED DEFINITIONS

Unless otherwise specified, the following terms as used herein have the meanings provided below.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate. Additionally, the term “substrate,” as used herein refers to surfaces that are untreated, unprimed or clean-blasted, and also to surfaces that have been primed or pretreated by various methods known to those of skill in the art, such as electrocoating treatments, for example.

Unless otherwise indicated, the term “polymer” includes both homopolymers and copolymers (i.e., polymers of two or more different monomers). As used herein, the term “(meth)acrylate” includes both acrylic and methacrylic monomers and homopolymers as well as copolymers containing the same.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

Embodiments of the invention described herein include compositions and methods for powder-coating a substrate. The methods include steps for applying at least a first powder composition to a substrate, wherein the composition includes a polyester resin, a curing agent, an impact modifier, and an onium ion catalyst. The methods further include curing the composition at temperatures of about 120° C. to 135° C.

In an embodiment, the methods described herein include applying at least a first powder composition to a substrate. The powder composition is a fusible composition that melts on application of heat to form a coating film. The powder is applied using methods known to those of skill in the art, such as, for example, electrostatic spray methods, to a film thickness of about 10 to about 50 microns, preferably 20 to 40 microns. In an aspect, the first powder composition is applied to either the clean (i.e., unprimed) or pretreated surface of a metal substrate, i.e., the first powder composition may be applied to a metal surface that is unprimed, that has been clean-blasted, or a surface that has been pretreated by various methods known to those of skill in the art, such as electrocoat, for example.

In an embodiment, the first powder composition includes at least one polymeric binder. The powder composition may also optionally include one or more pigments, opacifying agents or other additives.

Suitable polymeric binders generally include a film forming resin and a curing agent for the resin. The binder may be selected from any resin or combination of resins that provides the desired film properties. Suitable examples of polymeric binders include amorphous and crystalline thermosetting and/or thermoplastic materials, and can be made with epoxy, polyester, polyurethane, polyamide, acrylic, polyvinylchloride, nylon, fluoropolymer, silicone, other resins, or combinations thereof. Thermoset materials are preferred for use as polymeric binders in powder coating applications, and epoxies, polyesters and acrylics are particularly preferred. If desired, elastomeric resins may be used for certain applications. In an aspect, specific polymeric binders or resins are included in the powder compositions described herein depending on the desired end use of the powder-coated substrate. For example, certain high molecular weight polyesters show superior corrosion resistance and are suitable for use on substrates used for interior and exterior applications.

Similarly, amorphous polyesters are useful in applications where clarity, color, and chemical resistance are desired.

Examples of preferred binders include the following: carboxyl-functional polyester resins, carboxyl-functional polyester resins cured with epoxide-functional compounds (e.g., triglycidyl-isocyanurate or TGIC), carboxyl-functional polyester resins cured with polymeric epoxy resins, carboxyl-functional polyester resins cured with glycidyl-functional acrylic resins, carboxyl-functional acrylic resins cured with polymeric epoxy resins. The curing reaction is preferably induced thermally.

In an embodiment, the polymeric binder of the powder composition is a carboxyl-functional polyester resin, preferably a resin suitable for use in a thermosetting powder composition with epoxide functional compounds. Conventionally, resins with low acid numbers (i.e., less than about 40) are preferred, as these resins produce smooth, glossy coatings with good mechanical characteristics and reduced demand for epoxide-functional curing agents, such as, for example, TGIC. Resins with high acid numbers (i.e., above about 40) require increased levels of curing agents, which traditionally tend to reduce the Tg of the powder coating, leading to greater tendency toward sintering during storage. Surprisingly, the carboxyl-functional polyester resin as described herein has an acid number of preferably at least about 40, more preferably about 45 to 60, and also demonstrates a high Tg for good sintering resistance during storage as seen with low acid number resins, while maintaining excellent smoothness and gloss as well as optimal weathering characteristics.

In an embodiment, the carboxyl-functional polyester resin is made in a single step process, by reaction of an aromatic diacid, such as, for example, isophthalic acid, with a hydroxy-functional compound, i.e., a diol. In an embodiment, the predominantly used aromatic acid is isophthalic acid, for optimum resistance to weathering. Without limiting to theory, it is believed that a single step process may be used where the diacid is sufficiently soluble in the reaction media. Some acids, such as, for example, terephthalic acid, are less soluble in the reaction media, and therefore less suitable for use in a single step process when a carboxyl-functional composition is the desired end product. The use of less soluble acids such as, for example, terephthalic acid, in the resin composition also leads to reduced weathering resistance compared to isophthalic acid.

Accordingly, in a preferred aspect, the carboxyl-functional polyester resin used in the methods and compositions described herein is an isophthalic acid-derived polyester resin made by a single step process and having an acid number of preferably at least about 40, more preferably about 45 to 60, with molecular weight (Mn) of preferably about 1000 to 10,000, more preferably 1500 to 7,000, and most preferably 2000 to 2600.

In order for a powder coating composition to be effective, the composition must be resistant to sintering or substantially non-sintering, i.e., the powder composition must retain its particulate characteristics even when exposed to specific conditions. The sintering resistance of a powder composition is typically maintained by using compositions having a Tg of 45° C. or higher. However, high Tg compositions of the prior art do not demonstrate optimum coalescing or leveling when cured at reduced temperatures less than about 140° C., resulting in poor film formation and inadequate mechanical properties. Conventionally, therefore, powder coatings which are intended for reduced temperature cure are generally formulated with resins having reduced Tg, resulting in increased tendency for the powder coating to sinter and create lumps during storage. Surprisingly, the carboxyl-functional polyester resin described herein has a glass transition temperature (Tg) of at least 50° C., more preferably about 55° C. to 70° C., and most preferably about 60° C. to 65° C., and is included in a powder coating composition capable of cure at low temperatures of 120° C. to 135° C. without any problems with coalescing or sintering typically expected at high Tg.

In an embodiment, the powder composition described herein is a thermosetting composition including a polymeric binder and a curing agent or crosslinker. In an aspect, curing agents include compounds that can be used as crosslinkers for acid-functional or carboxyl-terminated polyester resins. Curing agents or crosslinkers of this type include, without limitation, epoxy-functional compounds, amides, substituted alkyl amides, bisamides, and the like. In a preferred aspect, the curing agent or crosslinking compound is an epoxide-functional compound. Typical epoxide-functional curing agents are polyepoxide compounds with epoxy equivalent weight of preferably at least about 10, more preferably 50 to 500, and most preferably about 80 to 300. In an aspect, the curing agent is selected to have preferably 0.1 to 5, more preferably 0.5 to 1.5, and most preferably 0.8 to 1.2 epoxy groups per equivalent carboxyl groups in the carboxyl-functional polyester resin. Epoxy-functional curing agents include, without limitation, triglycidyl isocyanurate (TGIC), triglycidyl trimellitate, diglycidyl terephthalate, diglycidyl isophthalate, glycidyl-functional acrylic resins, and the like.

In a preferred embodiment, the polymeric binder of the powder composition includes TGIC as an epoxy-functional curing agent or crosslinker. TGIC, a triazine compound with reactive epoxy functional groups, is known in the art as a curing agent for acid-functional resins, such as acrylic resins, polyester resins, and the like, for example. These TGIC-reactive resins are known to have high hardness, and good chemical resistance. If the polymeric binder is a polyester resin derived primarily from isophthalic acid, such cured films generally offer optimum resistance to weathering, but suffer from poor flexibility and impact resistance. Powder compositions typically have TGIC content in the range of about 3 to 9 wt %, based on the total weight of the resin and crosslinker. Without limiting to theory, it is believed that higher amounts of TGIC tend to plasticize the coating composition, and higher quantities of TGIC have not been traditionally favored in the art. Conventional powder coating compositions therefore typically include low amounts of TGIC (i.e., less than about 10 wt %) with resins having low acid numbers and relatively low resin Tg if good flow and leveling at reduced cure temperatures are needed. Surprisingly, the compositions described herein include preferably at least about 10 wt %, more preferably 10 to 15 wt % TGIC, based on the total weight of the resin and crosslinker, with resins having high acid numbers (i.e., at least about 40 or higher) and high resin Tg (i.e., at least about 50° C. or higher).

Without limiting to theory, it is believed that the mechanical properties of a powder coating may be further improved by using additives that enhance the impact resistance of the coating composition. Accordingly, in an embodiment, the first powder composition optionally includes at least one impact modifier. Conventionally, impact modifiers are graft copolymers of crosslinked alkyl (meth)acrylate rubbers with other alkyl (meth)acrylates, styrene, acrylonitrile, and the like, and have two or more layers. In an aspect, the layers of the impact modifier have a core-shell structure, with the core preferably including, without limitation, homopolymers or copolymers of butadiene, sytrene, (meth) acrylic monomers, co-polymers of butadiene and (meth)acrylic monomers, copolymers of butadiene, (meth)acrylic monomers, vinyl ester monomers, vinyl halide monomers, and the like, or combinations thereof. The shell preferably includes, without limitation, polymers or graft copolymers of alkyl (meth)acrylate rubbers and the like. In a preferred aspect, the impact modifier has a butadiene or (meth)acrylate core, with a polymethyl methacrylate (PMMA) shell. In an embodiment, the powder composition described herein includes about up to 10 wt % impact modifier, preferably about 0 wt % to 5 wt %, more preferably about 2 wt % to 4 wt %, based on the total weight of the powder composition.

In an embodiment, the powder composition described herein is capable of cure at temperatures of about 120° C. to 135° C. Accordingly, the composition includes additives that help obtain low cure temperatures, such as catalysts, for example. In an aspect, the catalyst is a cationic compound, preferably a salt of an onium ion compound, including for example, quarternary ammonium salts, phosphonium ion salts, oxonium ion salts, and the like. In a preferred aspect, the onium ion salt is a phosphonium ion salt, including for example, phosphonium bromide, ethyltriphenyl phosphonium bromide, ethyltriphenyl phosphonium iodide, formyl methylene triphenyl phosphorane, formyl methyl triphenyl phosphonium chloride, benzoyl methylene triphenyl phosphorane, phenyl triethyl phosphonium bromide, methoxy carbonyl methyl phosphonium bromide, ethyl triphenyl phosphoranylidene acetate, methyl triphenyl phosphoranylidene acetate, ethoxy carbonyl methyl triphenyl phosphonium bromide, ethyl triphenyl phosphonium acetate-acetic acid complex, and combinations thereof.

In an embodiment, the amount of catalyst in the compositions described herein is dependent on the reactants used and the desired cure temperature. The onium ion salt catalyst is included in an amount sufficient to allow the powder composition to cure at low temperatures of about 120° C. to 135° C. In an aspect, the onium ion catalyst is present in an amount of preferably about 0.01 to 1 wt %, more preferably 0.05 to 0.5 wt %, most preferably 0.1 to 0.5 wt %, based on the total weight of the powder composition.

Conventionally, low cure temperatures have been associated with poor mechanical properties and heterogeneous or poor film formation as a result of premature reaction and partial crosslinking of the coating composition prior to cure (i.e., during extrusion, for example). In order to avoid problems with sintering of the powder coating during storage, the

Tg of the composition is conventionally maintained above 50° C. However, such high Tg values are typically associated with high viscosity, which hinders the formation of a smooth, homogenous film at reduced cure temperatures. Surprisingly, in the methods and compositions described herein, low cure temperatures of about 120° C. to 135° C. are achieved with resin Tg of at least 50° C., preferably at least 60° C., while maintaining a relatively low viscosity of about 300 to 500 poise at 150° C. and producing coatings with optimal surface smoothness and mechanical properties.

The powder composition may include other additives. These other additives can improve the application of the powder coating, the melting and/or curing of that coating, or the performance or appearance of the final coating. Examples of optional additives which may be useful in the powder include: cure catalysts, antioxidants, color stabilizers, slip and mar additives, UV absorbers, hindered amine light stabilizers, conductivity additives, tribocharging additives, anti-corrosion additives, fillers, texture agents, degassing additives, flow control agents, thixotropes, and edge coverage additives.

The powder coating composition described herein is made by conventional methods known in the art. The polymeric binder is dry mixed together with the additives, and then is typically melt blended by passing through an extruder. The resulting extrudate is solidified by cooling, and then ground or pulverized to form a powder. In an embodiment, the carboxyl-functional resin, TGIC and the impact modifier are dry-mixed together and melt blended, with the onium ion catalyst being added to the melt blend prior to extrusion. Other methods may also be used. For example, one alternative method uses a binder that is soluble in liquid carbon dioxide. In that method, the dry ingredients are mixed into the liquid carbon dioxide and then sprayed to form the powder particles. If desired, powders may be classified or sieved to achieve a desired particle size and/or distribution of particle sizes.

The resulting powder is at a size that can effectively be used by the application process. Practically, particles less than 10 microns in size are difficult to apply effectively using conventional electrostatic spraying methods. Consequently, powders having median particle size less than about 25 microns are difficult to electrostatically spray because those powders typically have a large fraction of small particles. Preferably the grinding is adjusted (or sieving or classifying is performed) to achieve a powder median particle size of about 25 to 150 microns, more preferably 30 to 70 microns, most preferably 30 to 50 microns.

Optionally, other additives may be used in the present invention. As discussed above, these optional additives may be added prior to extrusion and be part of the base powder, or may be added after extrusion. Suitable additives for addition after extrusion include materials that would not perform well if they were added prior to extrusion, materials that would cause additional wear on the extrusion equipment, or other additives.

Additionally, optional additives include materials which are feasible to add during the extrusion process, but may also be added later. The additives may be added alone or in combination with other additives to provide a desired effect on the powder finish or the powder composition. These other additives can improve the application of the powder, the melting and/or curing, or the final performance or appearance. Examples of optional additives which may be useful include: cure catalysts, antioxidants, color stabilizers, slip and mar additives, conductivity additives, tribocharging additives, anti-corrosion additives, fillers, texture agents, degassing additives, flow control agents, thixotropes, and edge coverage additives.

Other preferred additives include performance additives such as rubberizers, friction reducers, and microcapsules. Additionally, the additive could be an abrasive, a heat sensitive catalyst, an agent that helps create a porous final coating, or that improves wetting of the powder.

Techniques for preparing powder compositions are known to those of skill in the art. Mixing can be carried out by any available mechanical mixer or by manual mixing. Some examples of possible mixers include Henschel mixers (available, for example, from Henschel Mixing Technology, Green Bay, Wis.), Mixaco mixers (available from, for example, Triad Sales, Greer, S.C. or Dr. Herfeld GmbH, Neuenrade, Germany), Marion mixers (available from, for example, Marion Mixers, Inc., 3575 3rd Avenue, Marion, Iowa), invertible mixers, Littleford mixers (from Littleford Day, Inc.), horizontal shaft mixers and ball mills. Preferred mixers would include those that are most easily cleaned.

Powder coatings are generally manufactured in a multi-step process. Various ingredients, which may include resins, curing agents, pigments, additives, and fillers, are dry-blended to form a premix. This premix is then fed into an extruder, which uses a combination of heat, pressure, and shear to melt fusible ingredients and to thoroughly mix all the ingredients. The extrudate is cooled to a friable solid, and then ground into a powder. Depending on the desired coating end use, the grinding conditions are typically adjusted to achieve a powder median particle size of about 25 to 150 microns.

The final powder may then be applied to an article by various means including the use of fluid beds and spray applicators. Most commonly, an electrostatic spraying process is used, wherein the particles are electrostatically charged and sprayed onto an article that has been grounded so that the powder particles are attracted to and cling to the article. After coating, the article is heated. This heating step causes the powder particles to melt and flow together to coat the article. Optionally, continued or additional heating may be used to cure the coating.

The coating is optionally cured, and such curing may occur via continued heating, subsequent heating, or residual heat in the substrate. In an embodiment, a powder composition applied to a substrate is heated or baked by conventional methods, to a temperature of approximately about 120° C. (250° F.) for about 15 minutes. Alternatively, the applied composition may be heated or baked to a temperature of approximately about 135° C. (275° F.) for 10 minutes. Under these conditions, the coating is fully cured, i.e., sufficient crosslinking occurs to provide a cured coating with optimal mechanical properties and surface smoothness.

The compositions and methods described herein may be used with a wide variety of substrates. Typically and preferably, the powder coating compositions described herein are used to coat metal substrates, including without limitation, unprimed metal, clean-blasted metal, and pretreated metal, including plated substrates, ecoat-treated metal substrates, and substrates that are the same color as the powder coating composition. Typical pretreatments for metal substrates include, for example, treatment with iron phosphate, zinc phosphate, and the like. Metal substrates can be cleaned and pretreated using a variety of standard processes known in the industry. Examples include, without limitation, iron phosphating, zinc phosphating, nanoceramic treatments, various ambient temperature pretreatments, zirconium containing pretreatments, acid pickling, or any other method known in the art to yield a clean, contaminant-free surface on a substrate.

The coating compositions and methods described herein are not limited to conversion coatings, i.e., parts or surfaces treated with conversion coatings. Moreover, the coating compositions described herein may be applied to substrates previously coated by various processes known to persons of skill in the art, including for example, ecoat methods, plating methods, and the like. There is no expectation that substrates to be coated with the compositions described herein will always be bare or unprimed metal substrates.

Preferably, the coated substrate has desirable physical and mechanical properties. Typically, the final film coating will have a thickness of 25 to 200 microns, preferably 50 to 150 microns, more preferably 75 to 125 microns.

### EXAMPLES

Unless indicated otherwise, the following test methods were utilized in the Example(s) that follow(s).

### PCI Smoothness

The smoothness of cured coatings made from the powder compositions is determined using visual standards developed by the Powder Coating Institute. Under this standard, a visual scale of ten powder-coated panels, graded from 1 (high roughness/orange peel) to 10 (very smooth, high gloss finish) is used. To determine relative smoothness, a powder-coated sample is visually compared with the standard panels, and a smoothness grade is assigned by judging which standard panel is closest to the sample.

### Impact Resistance

The direct and reverse impact resistance of cured coatings prepared from the powder compositions is tested using the method described in ASTM D2794 (Standard Test Method for Resistance of Organic Coatings to the Effects of Rapid Deformation).

### Flexibility

The flexibility of cured coatings prepared from the powder compositions is tested using the Mandrel Bend Test, as described in ASTM D522 (Standard Test Methods for Mandrel Bend Test for Attached Organic Coatings).

### Solvent Resistance

The solvent resistance of cured coatings prepared from the powder compositions is tested using the method described in ASTM D4752 (Standard Test Methods for Measuring MEK Resistance). The results are rated visually on a scale of 1 to 5, where 1 represents complete failure (i.e., the solvent penetrates down to the substrate after 100 double rubs) and 5 represents no effect (i.e., the solvent shows no visually detectable effect on the coating after 100 double rubs).

### Pencil Hardness

The hardness of cured coatings prepared from the powder compositions is tested using by the pencil method, as described in ASTM D3363 (Standard Test Method for Film Hardness by Pencil Test).

### Gloss

The gloss or surface smoothness of cured coatings prepared from the powder compositions is tested as 20-degree gloss, using the method described in ASTM D523 (Standard Test Method for Specular Gloss).

### Melt Viscosity

The melt viscosity of the resin is determined on a Brookfield Model Cap 2000H viscometer set to a temperature of 150° C., and operating at a rotational speed of 100 RPM using a number 06 spindle.

### Example 1

### Comparison of Coating Types

Powder compositions were prepared with acid number and measured Tg values as shown in Table 1. Powder composition #1 is a commercially available low cure product formulated to cure at 163° C. (325° F.), powder composition #2 is a modified version of the composition #1 formulated to cure at a lower temperature of 135° C. (275° F.), and powder composition #3 is the experimental product, formulated using the TGIC-reactive isophthalic acid-derived polyester resin described herein. The physical properties of these coatings were determined after a 15 minute cure at the temperatures indicated in Table 1.

TABLE 1
Comparison of Physical Properties of Powder Coatings

| | Composition | Composition | Composition |
|---|---|---|---|
| | #1 | #2 | #3 |
| Resin Acid Number | 35 | 35 | 50 |
| Resin Melt Viscosity | 536 | 536 | 353.5 |
| (150° C.) | | | |
| Measured Tg (° C.) | 50 | 46 | 50 |
| Cure Temperature (° C.) | 165 | 135 | 135 |
| PCI Smoothness | 6 | 2 | 6 |
| Direct Impact | 120 | 80 | 160 |
| Reverse Impact | 120 | 80 | 160 |
| Mandrel Bend (in) | 1/8 | 3/8 | 1/8 |
| MEK Resistance | 3 | 2 | 4 |
| Pencil Hardness | 2 H | H | 2 H |
| 20° Gloss | 80 | 64 | 80 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

1-20. (canceled)

21. A coated article, comprising:
a metal substrate; and
a cured coating disposed on at least a portion of the substrate, the coating prior to cure comprising a storage-stable coating composition having a Tg of at least 50° C. including
a carboxy-functional polyester resin having an acid number of about 45 to 65 and a melt viscosity of less than about 500 poise at 150° C.; and
a curing agent,
wherein the composition is fully cured at a temperature of about 120° C. to 135° C.

22. A method, comprising:
providing a metal substrate;
providing a storage-stable powder coating composition having a Tg of at least 50° C. comprising
a carboxy-functional polyester resin having an acid number of about 45 to 65 and a melt viscosity of less than about 500 poise at 150° C.; and
a curing agent;
applying the coating composition to at least a portion of the metal substrate; and
curing the composition at a temperature of about 120° C. to 135° C. to obtain a corrosion-resistant coating with optimal smoothness.

23. A powder coating composition, comprising:
a carboxyl-functional polyester resin having an acid number of about 45 to 65 and a melt viscosity of less than about 500 poise at 150 C;
a curing agent;
optionally, an impact modifier; and
a catalyst,
wherein the powder composition has Tg of at least about 50° C., is storage-stable, and is capable of cure at temperatures of 120 to 135° C.

24. The article of claim 21, wherein the carboxyl-functional polyester resin is an isophthalic acid-derived polyester resin.

25. The article of claim 21, wherein the carboxyl-functional polyester resin has Tg of at least about 65° C.

26. The article of claim 21, wherein the carboxyl-functional polyester resin has Tg of about 55 to 70° C.

27. The article of claim 21, wherein the carboxyl-functional polyester resin is present in amount of about 80 to 90 weight percent, based on the total weight of the composition.

28. The article of claim 21, wherein the curing agent is epoxy-functional and has epoxy equivalent weight of about 50 to 500.

29. The article of claim 28, wherein the epoxy-functional curing agent is selected to have 0.5 to 1.5 epoxy groups per equivalent of carboxyl in the carboxyl-functional polyester resin.

30. The article of claim 28, wherein the epoxy-functional curing agent is triglycidyl isocyanurate (TGIC).

31. The article of claim 28, wherein the epoxy-functional curing agent is present in an amount of about 1 to 10 weight percent, based on the total weight of the composition.

32. The article of claim 21, wherein the coating further comprises a core-shell impact modifier composition.

33. The article of claim 32, wherein the core component of the impact modifier is selected from polymers of butadiene, co-polymers of butadiene and styrene, (meth) acrylic monomers, co-polymers of butadiene and (meth)acrylic monomers, copolymers of butadiene, (meth)acrylic monomers, and combinations thereof

34. The article of claim 32, wherein the shell component of the impact modifier is a grafted polymethyl methacrylate (PMMA) polymer.

35. The article of claim 32, wherein the impact modifier is present in an amount of about 0 to 5 weight percent, based on the total weight of the composition.

36. The article of claim 21, wherein the coating further comprises an onium ion catalyst.

37. The article of claim 36, wherein the onium oil salt is a phosphonium ion salt selected from phosphonium bromide, triphenyl ethyl phosphonium bromide, triphenyl ethyl phosphonium iodide, formyl methylene triphenyl phosphorane, formyl methyl triphenyl phosphonium chloride, benzoyl methylene triphenyl phosphorane, phenyl triethyl phosphonium bromide, methoxy carbonyl methyl phosphonium bromide, ethyl triphenyl phosphoranylidene acetate, methyl triphenyl phosphoranylidene acetate, ethoxy carbonyl methyl triphenyl phosphonium bromide, ethyl triphenyl phosphonium acetate-acetic acid complex, and combinations thereof.

38. The article of claim 36, wherein the onium ion catalyst is present in an amount sufficient to allow the composition to cure at temperatures of about 120° C. to 135° C.

39. The article of claim 36, wherein the onium ion catalyst is present in an amount of about 0.01 to 0.1 weight percent, based on the total weight of the composition.

40. The article of claim 21, wherein the composition is fully cured in a time period of about 15 minutes at 120° C.

41. The article of claim 21, wherein the composition is fully cured in a time period of about 10 minutes at 135° C.
